(19) United States
(12) Patent Application Publication
(10) Pub. No.: US 2018/0270136 A1
(43) Pub. Date: Sep. 20, 2018

(54) COMMUNICATIONS SYSTEM

(71) Applicant: HONDA MOTOR CO., LTD., Tokyo (JP)

(72) Inventor: Atsushi Kurauchi, Wako-shi (JP)

(21) Appl. No.: 15/917,969

(22) Filed: Mar. 12, 2018

(30) Foreign Application Priority Data
Mar. 16, 2017 (JP) 2017-050690

(51) Int. Cl. H04L 12/26; H04L 12/40

(52) U.S. Cl. CPC H04L 43/10; H04L 2012/40273; H04L 12/40032

(57) ABSTRACT

In a communications system, a first communications device generates a trigger signal and transmits the trigger signal to a communications network. A second communications device receives the trigger signal through the communications network, generates a response signal with respect to the trigger signal, and transmits the response signal to the communications network. A monitor device receives the trigger signal and the response signal through the communications network, and determines whether the communications network is in an abnormal state on the basis of a reception status thereof.

### CROSS-REFERENCE TO RELATED APPLICATION

This application is based upon and claims the benefit of priority from Japanese Patent Application No. 2017-050690 filed on Mar. 16, 2017, the contents of which are incorporated herein by reference.

### BACKGROUND OF THE INVENTION

### Field of the Invention

The present invention relates to a communications system that can determine whether a communications network is in an abnormal state.

### Description of the Related Art

Japanese Laid-Open Patent Publication No. 2013-187555 (hereinafter referred to as “JP 2013-187555 A”) discloses a communications system intended to deal with an unauthorized access appropriately ([0001], [0007], Abstract). In JP 2013-187555 A, an unauthorized access detection unit 44 of a GW device 4 determines whether the CANID is wrong (S32 in FIG. 4), whether the transmission timing is wrong (S34), and whether the transmission order is wrong (S35). In addition, the unauthorized access detection unit 44 determines whether the data are wrong (S36) and whether the communications device is authenticated (S37) ([0054] to [0060]). Furthermore, the detection of the unauthorized access is also described in step S106 in FIG. 2, steps S402, S404 in FIG. 6, steps S52, S54 in FIG. 7, steps S603, S612 in FIG. 9, step S73 in FIG. 10, and the like.

Among these determinations, in the determination as to whether the transmission order is wrong, the unauthorized access detection unit 44 stores the correct order of transmitted CAN messages (the order in one cycle). Then, if the order of the received CAN messages is different from the stored order, the unauthorized access detection unit 44 determines that the access is unauthorized ([0057]).

### SUMMARY OF THE INVENTION

As described above, in the determination as to the transmission order in JP 2013-187555 A, the order in one cycle is used ([0057]). Therefore, the technique according to JP 2013-187555 A is applicable only to periodic signals. Moreover, JP 2013-187555 A describes the unauthorized access only, and does not describe other abnormal states of the communications network (for example, abnormal operation of ECU).

The problem as above is not limited to the vehicle and also applies to other communications networks.

The present invention has been made in view of the problem as above, and an object is to provide a communications system that can more appropriately deal with the abnormal state (including unauthorized access) of the communications network.

A communications system according to the present invention includes: a first communications device configured to generate a trigger signal and transmit the trigger signal to a communications network; a second communications device configured to receive the trigger signal through the communications network, generate a response signal with respect to the trigger signal, and transmit the response signal to the communications network; and a monitor device configured to receive the trigger signal and the response signal through the communications network, and determine whether the communications network is in an abnormal state on a basis of a reception status of the trigger signal and the response signal.

According to the present invention, the monitor device determines whether the communications network is in the abnormal state on the basis of the reception status of the trigger signal from the first communications device and the response signal from the second communications device. The response signal is generated with respect to the trigger signal from the first communications device. Therefore, regardless of whether the trigger signal is periodic, whether the communications network is in the abnormal state can be determined based on the reception status of the trigger signal and the response signal. The abnormal state herein described corresponds to, for example, a state in which an unauthorized access device spoofs as the second communications device and a state in which an operation failure occurs in the second communications device that is authenticated.

The monitor device may be configured to determine whether the communications network is in the abnormal state on a basis of an order of receiving the trigger signal and the response signal. Thus, the monitor device can determine whether the communications network is in the abnormal state by a relatively simple method.

The monitor device may be configured to determine whether the communications network is in the abnormal state on a basis of number of times of receiving the response signal after the trigger signal is received and before the trigger signal is received next time, or number of times of receiving the trigger signal after the response signal is received and before the response signal is received next time. Thus, whether the communications network is in the abnormal state can be determined by using the reception interval of the trigger signals or the reception interval of the response signals.

If the trigger signal is received, the second communications device may be configured to transmit the response signal within a first predetermined time. If the response signal is not received within a second predetermined time after the trigger signal is received, the monitor device may be configured to determine that the communications network is in the abnormal state. Thus, the monitor device can determine whether the communications network is in the abnormal state by a relatively simple method.

The second predetermined time may be the same as the first predetermined time. In other words, the monitor device may determine whether the communications network is in the abnormal state by monitoring the control cycle (calculation cycle, transmission cycle, or the like) in which the second communications device should transmit the response signal. Thus, the monitor device can set relatively accurately the timing at which the monitor device receives the response signal.

The above and other objects, features, and advantages of the present invention will become more apparent from the following description when taken in conjunction with the accompanying drawings in which a preferred embodiment of the present invention is shown by way of illustrative example.

### BRIEF DESCRIPTION OF THE DRAWINGS

FIG. 1 is a schematic overall structure diagram illustrating a part of a vehicle including a communications system according to one embodiment of the present invention;

FIG. 2 is a diagram illustrating a structure of a data frame in the embodiment;

FIG. 3 is a flowchart of a trigger signal transmission control in the embodiment;

FIG. 4 is a flowchart of a response signal transmission control in the embodiment; FIG. 5 is a flowchart of a monitor control in the embodiment;

FIG. 6 is an explanatory view illustrating one example in which the trigger signal transmission control, the response signal transmission control, and the monitor control are performed when a communications network is in a normal state in the embodiment;

FIG. 7 is an explanatory view illustrating one example in which the trigger signal transmission control, the response signal transmission control, and the monitor control are performed when the communications network is in an abnormal state in the embodiment; and

FIG. 8 is a flowchart of a monitor control according to a modification.

### DESCRIPTION OF THE PREFERRED EMBODIMENTS

### A. Embodiment

### <A-1. Structure>

### [A-1-1. Overall Structure]

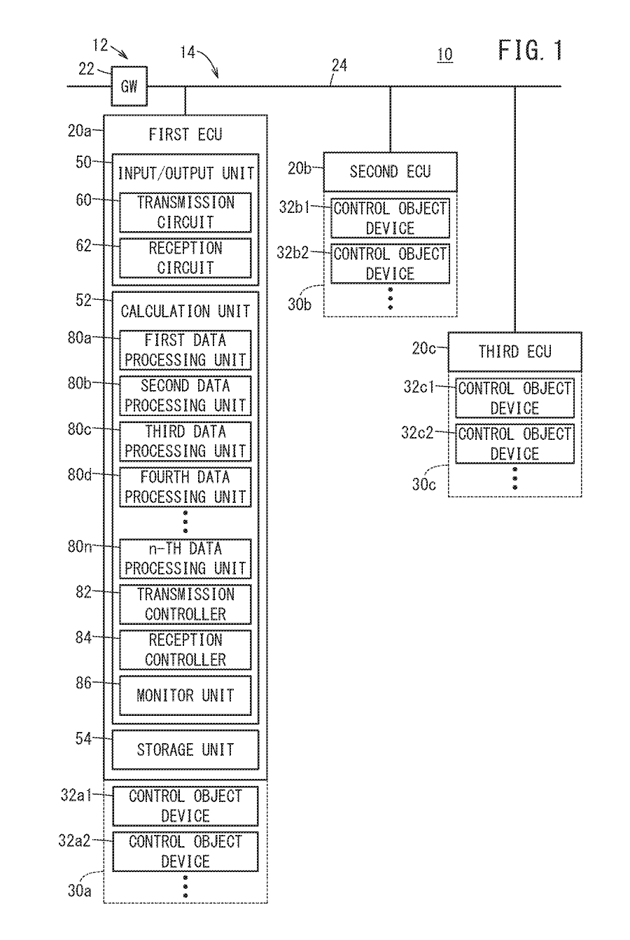

FIG. 1 is a schematic overall structure diagram illustrating a part of a vehicle 10 including a communications system 12 according to one embodiment of the present invention. The communications system 12 includes a plurality of communications networks 14 (hereinafter also referred to as “network 14” or “in-vehicle network 14”). However, FIG. 1 illustrates only one network 14.

### [A-1-2. In-Vehicle Network 14]

### (A-1-2-1. Outline of In-Vehicle Network 14)

The in-vehicle network 14 is a controller area network (CAN). Alternatively, the network 14 may be FlexRay, a local interconnect network (LIN), or the like. The in-vehicle network 14 includes a plurality of electronic control units 20a to 20c (hereinafter referred to as “ECUs 20a to 20c” or “first to third ECUs 20a to 20c”), a gateway 22, and a communications line 24. The ECUs 20a to 20c are collectively referred to as ECUs 20.

### (A-1-2-2. ECUs 20a to 20c)

### (A-1-2-2-1. Overall Structure of ECUs 20a to 20c)

Each ECU 20 is a transceiver (or node) that is connected to the communications network 14 (or communications line 24) and transmits or receives various signals to or from another ECU 20 through the communications network 14. Each ECU 20 may include only the function as a transmitter or a receiver.

The first ECU 20a controls control object devices 32a1, 32a2, . . . included in an own control object region 30a (hereinafter also referred to as “first control object region 30a”). Similarly, the second ECU 20b controls control object devices 32b1, 32b2, . . . included in an own control object region 30b (hereinafter also referred to as “second control object region 30b”), and the third ECU 20c controls control object devices 32c1, 32c2, . . . included in an own control object region 30c (hereinafter also referred to as “third control object region 30c”). In the description below, the control object regions 30a, 30b, 30c are collectively referred to as control object regions 30, and the control object devices 32a1, 32a2, 32b1, 32b2, 32c1, 32c2, . . . are collectively referred to as control object devices 32.

As the ECUs 20a to 20c, for example, an engine ECU, an electric power steering system ECU (hereinafter referred to as “EPS ECU”), a lane keep assist system ECU (hereinafter referred to as “LKAS ECU”), a vehicle behavior stabilizing control system ECU (hereinafter referred to as “VSA ECU”, VSA stands for vehicle stability assist), or a navigation ECU can be included.

The engine ECU controls the output of an engine that is not shown. The EPS ECU controls an electric power steering system that is not shown. The LKAS ECU controls a lane keep assist system that is not shown. The VSA ECU controls to stabilize a vehicle body by using a braking device that is not shown. The navigation ECU controls to navigate a route to a target point of the vehicle 10.

As illustrated in FIG. 1, the first ECU 20a includes an input/output unit 50, a calculation unit 52, and a storage unit 54. Each of the other ECUs 20b, 20c also includes a structure similar to that of the first ECU 20a; however, the structures of the ECUs 20b, 20c are not shown in FIG. 1.

### (A-1-2-2-2. Input/Output Unit 50)

The input/output unit 50 inputs and outputs signals. The input/output unit 50 can include an analog/digital converter and a digital/analog converter. The input/output unit 50 includes a transmission circuit 60 and a reception circuit 62 for performing the communications in the network 14.

### (A-1-2-2-3. Calculation Unit 52)

The calculation unit 52 controls the entire ECU 20. For example, the calculation unit 52 of the first ECU 20a controls the entire first ECU 20a. In this control, the calculation unit 52 uses programs and data stored in the storage unit 54. The calculation unit 52 includes a central processing unit (CPU). A part of the functions to be performed by the calculation unit 52 can be achieved by using a logic integrated circuit (IC).

As illustrated in FIG. 1, the calculation unit 52 includes first to n-th data processing units 80a to 80n (n is a natural number of 1 or more, for example, any of 5 to 10), a transmission controller 82, a reception controller 84, and a monitor unit 86.

The first to n-th data processing units 80a to 80n control the control object device 32 in the control object region 30 by performing various data processing. In the present embodiment, the first to n-th data processing units 80a to 80n perform first to n-th parameter signal transmission processes, thereby generating first to n-th control parameters Pc1 to Pcn. Then, the first to n-th data processing units 80a to 80n output the generated first to n-th control parameters Pc1 to Pcn through the transmission controller 82. In the description below, the first to n-th control parameters Pc1 to Pcn are collectively referred to as control parameters Pc.

The first to n-th control parameters Pc1 to Pcn are parameters indicating the state of the control object. The control object herein described may be the control object devices 32a1 to 32c2 themselves. Alternatively, the control object may be a particular function (for example, fuel injection).

For example, the calculation unit 52 of the engine ECU outputs the control parameter Pc related to the engine that the calculation unit 52 manages (for example, engine speed [rpm] and accelerator pedal opening [%]) to another ECU (for example, EPS ECU). The ECU having received the control parameter Pc performs its own control (for example, driving of an EPS motor that is not shown) by using the control parameter Pc.

The transmission controller 82 generates a data frame DF including the first to n-th control parameters Pc1 to Pcn generated by the first to n-th data processing units 80a to 80n, and outputs the data frame DF as first to n-th parameter signals Sp1 to Spn. In the description made below, the first to n-th parameter signals Sp1 to Spn are collectively referred to as parameter signals Sp.

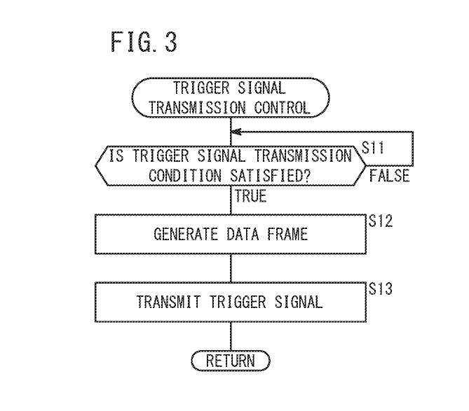

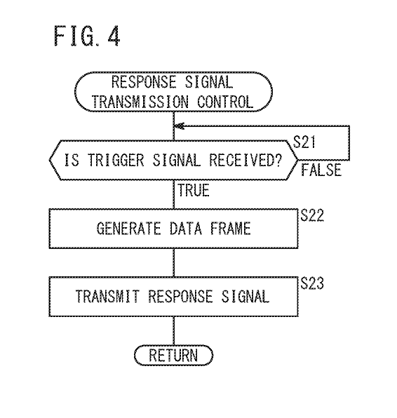

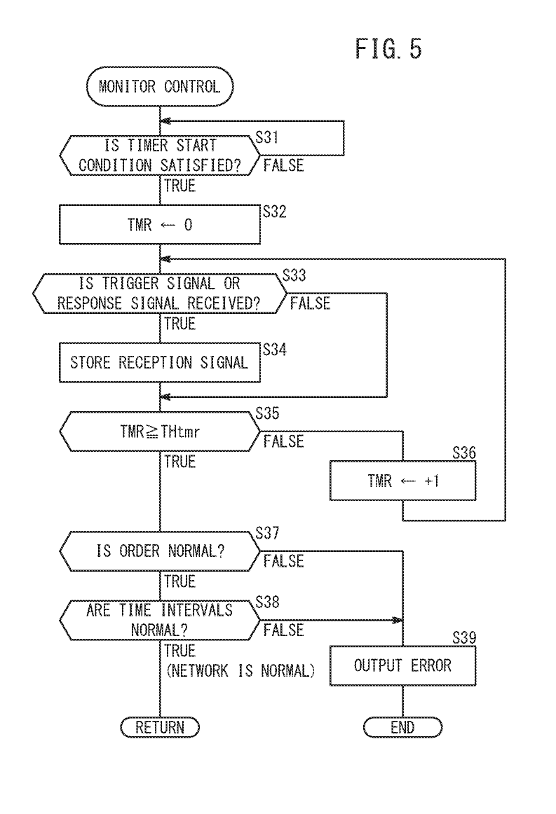

The transmission controller 82 according to the present embodiment performs a trigger signal transmission control to transmit a trigger signal St, and a response signal transmission control to transmit a response signal Sr. The trigger signal St is a signal that triggers generation and transmission of the response signal Sr in another ECU 20. The response signal Sr is a signal that is generated and transmitted at the time of the reception of the trigger signal St. The first to n-th parameter signals Sp1 to Spn described above can serve as trigger signals St and/or response signals Sr. The details of the trigger signal transmission control and the response signal transmission control will be described below with reference to FIG. 3 and FIG. 4.

The reception controller 84 receives the parameter signals Sp transmitted from another ECU 20, extracts control parameters Pc and parameter IDs (or message IDs), and then supplies those to the first to n-th data processing units 80a to 80n.

The monitor unit 86 is an abnormality detection unit that detects an abnormal state of the communications network 14. The monitor unit 86 according to the present embodiment performs a monitor control to detect the abnormal state of the communications network 14. The monitor unit 86 is formed as a part of programs executed by the CPU. Alternatively, the monitor unit 86 may be formed as a logic IC different from the CPU.

### (A-1-2-2-4. Storage Unit 54)

The storage unit 54 stores the programs and data to be used by the calculation unit 52, and includes a random access memory (hereinafter referred to as “RAM”). As the RAM, a volatile memory such as a register, and a nonvolatile memory such as a flash memory can be used. In addition to the RAM, the storage unit 54 may include a read only memory (hereinafter referred to as “ROM”).

### (A-1-2-3. Gateway 22)

The gateway 22 includes the function of connecting between the particular in-vehicle network 14 and another communications network that is not shown (including in-vehicle network and/or out-vehicle network).

<A-2. Control in Each of ECUs 20a to 20c>
[A-2-1. Outline of Control in Each of ECUs 20a to 20c]

Next, description is made of a control in each of ECUs 20a to 20c in the present embodiment. As described above, each of the ECUs 20a to 20c performs the control on each control object device 32 of the own control object region 30. Some of the control parameters Pc related to the control object that is managed by one of ECUs 20a to 20c are also used by a different one of the ECUs 20. The one ECU 20 outputs such control parameters to the different ECU 20.

The trigger signal St (for example, first parameter signal Sp1) transmitted from a certain ECU 20 (for example, first ECU 20a) is transmitted to a different ECU 20 through the network 14. The different ECU 20 having received that trigger signal St performs the own control by using the control parameter Pc included in the trigger signal St. In the present embodiment, the different ECU 20 having received the trigger signal St transmits the response signal Sr with respect to the received trigger signal St. In the description below, the ECU 20 that performs the trigger signal transmission control is also referred to as a transmission ECU 20t, and the ECU 20 that performs the response signal transmission control is also referred to as a response ECU 20r.

The different ECU 20 (monitor device) that has received both the trigger signal St and the response signal Sr determines whether the communications network 14 is in the abnormal state on the basis of the trigger signal St and the response signal Sr. The abnormal state herein described corresponds to, for example, a state in which an unauthorized access device spoofs as a different ECU 20 and a state in which an operation failure occurs in the different ECU 20 that is authenticated. In the description below, the control to determine whether the communications network 14 is in the abnormal state is also referred to as “monitor control” and the ECU 20 that performs the monitor control is also referred to as a monitor ECU 20mon.

### [A-2-2. Structure of Data Frame DF]

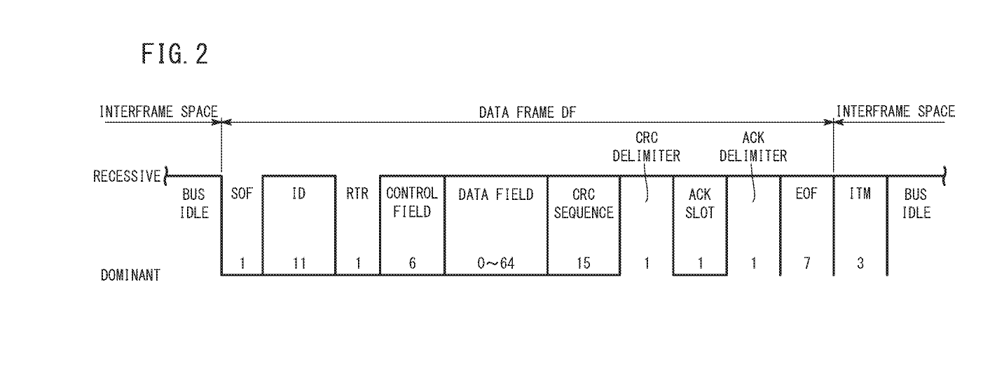

Next, a structure of the data frame DF used in the communications of the ECU 20 in the present embodiment is described. FIG. 2 is a diagram illustrating the structure of the data frame DF in the present embodiment. The data frame DF is similar to the one illustrated in FIG. 5 of International Publication No. 2013/171829.

As illustrated in FIG. 2, the data frame DF includes a start of frame (SOF), an ID field, a remote transmission request (RTR), a control field, a data field, a cyclic redundancy check (CRC) sequence, a CRC delimiter, an acknowledgement (ACK) slot, an ACK delimiter, and an end of frame (EOF). After the data frame DF, an intermission (ITM) is disposed.

Each field includes dominant “0” and/or recessive “1”. In FIG. 2, in a field that has a solid line only on a lower side (dominant) or an upper side (recessive), only a bit shown by the solid line can be selected. The numeral shown in a lower part of each field in FIG. 2 indicates a bit number of each field. For example, the SOF is 1 bit, the ID field is 11 bits, and the data field is 0 to 64 bits.

### [A-2-3. Trigger Signal Transmission Control]

FIG. 3 is a flowchart of the trigger signal transmission control in the present embodiment. In step S11, the transmission ECU 20t determines whether a trigger signal transmission condition is satisfied. The trigger signal transmission condition is, for example, the stop of the vehicle 10 (vehicle speed V=0 km/h) or the start of idling stop. If the trigger signal transmission condition is satisfied (S11: TRUE), the process advances to step S12. If the trigger signal transmission condition is not satisfied (S11: FALSE), step S11 is repeated.

In step S12, the transmission ECU 20t generates the data frame DF (FIG. 2) by using the control parameter Pc included in the trigger signal St. The data frame DF in step S12 is hereinafter also referred to as “first data frame DF1”. In step S13, the ECU 20 transmits the trigger signal St including the generated first data frame DF1.

The trigger signal transmission control can be performed for each kind of trigger signals St.

### [A-2-4. Response Signal Transmission Control]

FIG. 4 is a flowchart of the response signal transmission control in the present embodiment. In step S21, the response ECU 20r determines whether the trigger signal St is received. This determination is performed based on the parameter ID (message ID) included in the first data frame DF1 of the received signal, for example. Specifically, the parameter ID (reference ID) included in the trigger signal St that should be received by the response ECU 20r is set in advance, and based on whether the parameter ID included in the received signal coincides with the reference ID, whether the trigger signal St has been received is determined. If the trigger signal St is received (S21: TRUE), the process advances to step S22. If the trigger signal St is not received (S21: FALSE), step S21 is repeated.

In step S22, the response ECU 20r generates the data frame DF (FIG. 2) on the basis of the trigger signal St. The data frame DF generated in step S22 is hereinafter also referred to as “second data frame DF2”. The second data frame DF2 here includes, for example, the control parameter

Pc generated by the response ECU 20r at the time of the reception of the trigger signal St. Alternatively, the content of the second data frame DF2 may be completely the same as the content of the first data frame DF1 included in the trigger signal St (that is, the copy of the first data frame DF1). Further alternatively, the second data frame DF2 may be generated by processing the control parameter Pc included in the first data frame DF1, for example, in accordance with a predetermined rule.

In step S23, the response ECU 20r transmits the response signal Sr including the generated data frame DF (second data frame DF2). The response signal Sr may be transmitted with a delay of a predetermined number of transmission cycles T (or calculation cycles). With respect to one trigger signal St, a plurality of response signals Sr may be transmitted in order.

Note that the response signal transmission control can be performed for each kind of trigger signals St. The response signal transmission control can be regarded as one kind of trigger signal transmission control. That is to say, the reception of the trigger signal St can be used as the trigger signal transmission condition in step S11 in FIG. 3. Moreover, the response signal Sr can be transmitted as the trigger signal St in step S13.

### [A-2-5. Monitor Control]

FIG. 5 is a flowchart of the monitor control in the present embodiment. In the monitor control, whether the communications network 14 is in the abnormal state is determined based on the trigger signal St and the response signal Sr. In step S31, the monitor ECU 20mon determines whether a timer start condition is satisfied. In a case of performing the monitor control at a predetermined calculation cycle, for example, the monitor ECU 20mon determines whether the start timing of the calculation cycle has come. If the timer start condition is satisfied (S31: TRUE), the process advances to step S32. If the timer start condition is not satisfied (S31: FALSE), step S31 is repeated. Note that if the entire monitor control in FIG. 5 is performed at a predetermined calculation cycle, step S31 can be omitted.

In step S32, the monitor ECU 20mon resets the timer TMR (TMR←0). In step S33, the monitor ECU 20mon determines whether the trigger signal St or the response signal Sr has been received. This determination is performed based on, for example, the parameter ID (message ID) included in the data frame DF of the received signal. Specifically, the parameter IDs (reference IDs) included in the trigger signal St and the response signal Sr that should be received by the monitor ECU 20mon are set in advance, and based on whether the parameter ID included in the received signal coincides with the reference ID, whether the trigger signal St or the response signal Sr has been received is determined. Here, one of or both the trigger signal St and the response signal Sr may have a plurality of kinds.

If the trigger signal St or the response signal Sr is received (S33: TRUE), the monitor ECU 20mon stores the reception signal and the reception time thereof together in step S34. If the trigger signal St or the response signal Sr is not received (S33: FALSE) or after step S34, the process advances to step S35.

In step S35, the monitor ECU 20mon determines whether the timer TMR is more than or equal to a timer threshold THtmr. If the timer TMR is not more than or not equal to the timer threshold THtmr (S35: FALSE), the monitor ECU 20mon adds one to the timer TMR in step S36. The value to be added to the timer TMR may be other value. After step S36, the process returns to step S33. If the timer TMR is more than or equal to the timer threshold THtmr (S35: TRUE), the process advances to step S37.

In step S37, the monitor ECU 20mon determines whether the order of the trigger signals St and the response signals Sr received while the process of step S33 to step S36 is repeated is normal. If the order is normal (S37: TRUE), the process advances to step S38.

In step S38, the monitor ECU 20mon determines whether the time intervals of the trigger signals St and the response signals Sr received while the process of step S33 to step S36 is repeated are normal. If the time intervals are normal (S38: TRUE), the monitor ECU 20mon determines that the network 14 is normal. In this case, the monitor

ECU 20mon may store a normal flag in the storage unit 54, for example. Alternatively, the monitor ECU 20mon can store no data.

If the order of the trigger signals St and the response signals Sr is not normal (S37: FALSE) or the time intervals are not normal (S38: FALSE), the monitor ECU 20mon outputs an error indicating the abnormal state of the communications network 14 in step S39. Specifically, the monitor ECU 20mon turns on a warning lamp that is not shown. Alternatively, the monitor ECU 20mon may store a diagnostic trouble code (DTC) in the storage unit 54.

### [A-2-6. Specific Example]

### (A-2-6-1. Normal Case)

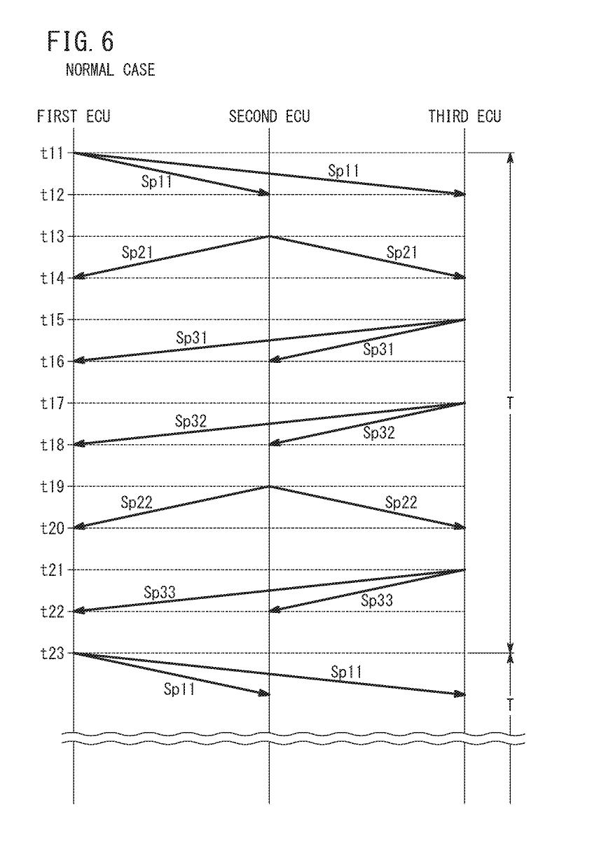

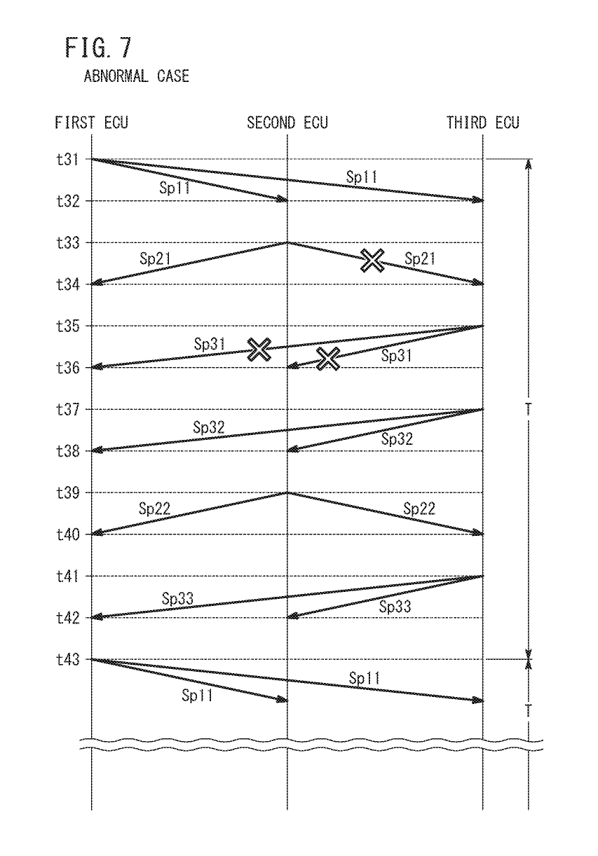

FIG. 6 is an explanatory view illustrating one example in which the trigger signal transmission control, the response signal transmission control, and the monitor control are performed when the communications network 14 is in a normal state in the present embodiment. In FIG. 6, the first ECU 20a performs the trigger signal transmission control and the monitor control, the second ECU 20b performs the trigger signal transmission control and the response signal transmission control, and the third ECU 20c performs the trigger signal transmission control and the response signal transmission control (this similarly applies to FIG. 7 in the description below).

When the trigger signal transmission condition is satisfied (S11 in FIG. 3: TRUE), the first ECU 20a that is currently performing the trigger signal transmission control transmits a parameter signal Sp11 (trigger signal St) to the network 14 at a time point t11 in FIG. 6 (S13 in FIG. 3).

The parameter signal Sp11 reaches the second ECU 20b and the third ECU 20c (time point t12 in FIG. 6). The trigger signal transmission condition here includes the reception of the parameter signal Sp33 (trigger signal St) from the third ECU 20c.

The first ECU 20a, which is also currently performing the monitor control, resets the timer TMR (S32 in FIG. 5) in accordance with the transmission of the parameter signal Sp11 (trigger signal St) and starts the counting of the timer TMR. In other words, the transmission of the parameter signal Sp11 (trigger signal St) is the timer start condition (S31 in FIG. 5) for the first ECU 20a.

In the response signal transmission control of the second ECU 20b, the parameter signal Sp11 from the first ECU 20a and the parameter signal Sp32 from the third ECU 20c are set as the trigger signals St. In other words, the second ECU 20b is programmed so as to transmit the parameter signals Sp21 and Sp22 (response signals Sr) with respect to the parameter signal Sp11 (trigger signal St) from the first ECU 20a and the parameter signal Sp32 from the third ECU 20c. Therefore, at the time of the reception of the parameter signal Sp11 (trigger signal St) from the first ECU 20a (S21 in FIG. 4: TRUE), the second ECU 20b transmits the parameter signal Sp21 to the network 14 at a time point t13 (S23 in FIG. 4). The parameter signal Sp21 reaches the first ECU 20a and the third ECU 20c (time point t14).

On the other hand, the third ECU 20c does not handle the parameter signal Sp11 from the first ECU 20a as the trigger signal St or the response signal Sr. In other words, the third ECU 20c is not programmed so as to transmit the response signal Sr with respect to the parameter signal Sp11. Therefore, the third ECU 20c does not perform a particular output with respect to the parameter signal Sp11 (trigger signal St) from the first ECU 20a.

In the monitor control of the first ECU 20a, the parameter signal Sp21 from the second ECU 20b and the parameter signal Sp33 from the third ECU 20c are set as the trigger signals St, and the parameter signal Sp31 from the third ECU 20c and the parameter signal Sp22 from the second ECU 20b are set as the response signals Sr. Therefore, at the time point t14, when the parameter signal Sp21 (trigger signal St) from the second ECU 20b is received (S33 in FIG. 5: TRUE), the first ECU 20a stores the received parameter signal Sp21 (S34).

In the response signal transmission control of the third ECU 20c, the parameter signal Sp21 from the second ECU 20b is set as the trigger signal St. Therefore, at the time point t14, when the parameter signal Sp21 (trigger signal St) from the second ECU 20b is received (S21 in FIG. 4: TRUE), the third ECU 20c transmits the parameter signal Sp31 as the response signal Sr to the network 14 at a time point t15 (S23). The parameter signal Sp31 reaches the first ECU 20a and the second ECU 20b (time point t16).

As described above, in the monitor control of the first ECU 20a, the parameter signal Sp31 from the third ECU 20c is set as the response signal Sr. Therefore, at the time point t16, when the parameter signal Sp31 (response signal Sr) from the third ECU 20c is received (S33 in FIG. 5: TRUE), the first ECU 20a stores the received parameter signal Sp31 (response signal Sr) (S34).

Since the trigger signal transmission condition is satisfied (S11 in FIG. 3: TRUE), the third ECU 20c that is currently performing the trigger signal transmission control transmits the parameter signal Sp32 (trigger signal St) to the network 14 at a time point t17 in FIG. 6 (S13 in FIG. 3). The parameter signal Sp32 reaches the first ECU 20a and the second ECU 20b (time point t18 in FIG. 6).

As described above, in the monitor control of the first ECU 20a, the parameter signal Sp32 from the third ECU 20c is set as the trigger signal St. Therefore, at the time point t18, when the parameter signal Sp32 (trigger signal St) from the third ECU 20c is received (S33 in FIG. 5: TRUE), the first ECU 20a stores the received parameter signal Sp32 (S34).

As described above, in the response signal transmission control of the second ECU 20b, the parameter signal Sp32 from the third ECU 20c is set as the trigger signal St. Therefore, when the parameter signal Sp32 (trigger signal St) from the third ECU 20c is received (S21 in FIG. 4: TRUE), the second ECU 20b transmits the parameter signal Sp22 (response signal Sr) to the network 14 at a time point t19 (S23 in FIG. 4). The parameter signal Sp22 reaches the first ECU 20a and the third ECU 20c (time point t20).

Since the trigger signal transmission condition is satisfied (S11 in FIG. 3: TRUE), the third ECU 20c that is currently performing the trigger signal transmission control transmits the parameter signal Sp33 (trigger signal St) to the network 14 at a time point t21 in FIG. 6 (S13 in FIG. 3). The parameter signal Sp33 reaches the first ECU 20a and the second ECU 20b (time point t22 in FIG. 6).

In this manner, in the monitor control of the first ECU 20a, the parameter signal Sp33 from the third ECU 20c is set as the trigger signal St. Therefore, at the time point t22, when the parameter signal Sp33 (trigger signal St) from the third ECU 20c is received (S33 in FIG. 5: TRUE), the first ECU 20a stores the received parameter signal Sp33 (S34).

After the timing at which it is expected to receive the parameter signal Sp33 (trigger signal St) from the third ECU 20c, the timer TMR becomes more than or equal to the timer threshold THtmr (S35 in FIG. 5: TRUE). In view of this, the first ECU 20a that is currently performing the monitor control performs the determination in steps S37 and S38 in FIG. 5.

In the example of FIG. 6, the order of signals received by the first ECU 20a is Sp21, Sp31, Sp32, Sp22, and Sp33, which is normal (S37: TRUE), and the time intervals of the signals Sp21, Sp31, Sp32, Sp22, and Sp33 are also normal (S38: TRUE). Therefore, the first ECU 20a determines that the network 14 is normal.

If the network 14 is normal, the process from the time point t11 to the time point t22 is repeated even after the time point t23. In other words, if the network 14 is normal, the process from the time point t11 to the time point t22 is repeated at the calculation cycle T. However, the calculation cycle T may be unfixed and the process from the time point t11 to the time point t22 may be performed at the time of the transmission of the trigger signal St, for example.

### (A-2-6-2. Abnormal Case)

FIG. 7 is an explanatory view illustrating one example in which the trigger signal transmission control, the response signal transmission control, and the monitor control are performed when the communications network 14 is in an abnormal state in the present embodiment. Specifically, some abnormality occurs in the communications between the second ECU 20b and the third ECU 20c (for example, abnormality that the ID of the second ECU 20b is recognized incorrectly by the third ECU 20c). However, the communications between the first ECU 20a and the second ECU 20b and the communications between the first ECU 20a and the third ECU 20c are normal. In a manner similar to FIG. 6, FIG. 7 illustrates the example in which the first ECU 20a performs the trigger signal transmission control and the monitor control, the second ECU 20b performs the trigger signal transmission control and the response signal transmission control, and the third ECU 20c performs the trigger signal transmission control and the response signal transmission control.

Since the trigger signal transmission condition is satisfied (S11 in FIG. 3: TRUE), the first ECU 20a that is currently performing the trigger transmission control transmits the parameter signal Sp11 (trigger signal St) to the network 14 at a time point t31 in FIG. 7 (S13 in FIG. 3). The parameter signal Sp11 reaches the second ECU 20b and the third ECU 20c (time point t32 in FIG. 7).

When the parameter signal Sp11 (trigger signal St) is received (S21 in FIG. 4: TRUE), the second ECU 20b transmits the parameter signal Sp21 to the network 14 at a time point t33 (S23 in FIG. 4). The parameter signal Sp21 reaches the first ECU 20a (time point t34). However, since some abnormality occurs in the communications between the second ECU 20b and the third ECU 20c, the parameter signal Sp21 does not reach the third ECU 20c or is not extracted in the third ECU 20c.

In the monitor control of the first ECU 20a, the parameter signal Sp21 from the second ECU 20b and the parameter signal Sp32 from the third ECU 20c are set as the trigger signals St, and the parameter signal Sp31 from the third ECU 20c and the parameter signal Sp22 from the second ECU 20b are set as the response signals Sr. Therefore, at the time point t34, when the parameter signal Sp21 (trigger signal St) from the second ECU 20b is received (S33 in FIG. 5: TRUE), the first ECU 20a stores the received parameter signal Sp21 (S34).

In the response signal transmission control of the third ECU 20c, the parameter signal Sp21 from the second ECU 20b is set as the trigger signal St; however, because of the abnormality, the parameter signal Sp21 from the second ECU 20b does not reach the third ECU 20c or is not extracted by the third ECU 20c. Therefore, the third ECU 20c does not transmit the response signal Sr with respect to the parameter signal Sp21 (trigger signal St) from the second ECU 20b (time point t35).

Since the trigger signal transmission condition is satisfied (S11 in FIG. 3: TRUE), the third ECU 20c that is currently performing the trigger signal transmission control transmits the parameter signal Sp32 (trigger signal St) to the network 14 at a time point t37 in FIG. 7 (S13 in FIG. 3). The parameter signal Sp32 reaches the first ECU 20a and the second ECU 20b (time point t38 in FIG. 7).

As described above, in the monitor control of the first ECU 20a, the parameter signal Sp32 from the third ECU 20c is set as the trigger signal St. Therefore, at the time t38, when the parameter signal Sp32 (trigger signal St) from the third ECU 20c is received (S33 in FIG. 5: TRUE), the first ECU 20a stores the received parameter signal Sp32 (S34).

As described above, in the response signal transmission control of the second ECU 20b, the parameter signal Sp32 from the third ECU 20c is set as the trigger signal St. Therefore, when the parameter signal Sp32 (trigger signal

St) from the third ECU 20c is received (S21 in FIG. 4: TRUE), the second ECU 20b transmits the parameter signal Sp22 to the network 14 at a time point t39 (S23 in FIG. 4). The parameter signal Sp22 reaches the first ECU 20a and the third ECU 20c (time point t40).

Since the trigger signal transmission condition is satisfied (S11 in FIG. 3: TRUE), the third ECU 20c that is currently performing the trigger signal transmission control transmits the parameter signal Sp33 (trigger signal St) to the network 14 at a time point t41 in FIG. 7 (S13 in FIG. 3). The parameter signal Sp33 reaches the first ECU 20a and the second ECU 20b (time point t42 in FIG. 7).

As described above, in the monitor control of the first ECU 20a, the parameter signal Sp33 from the third ECU 20c is set as the trigger signal St. Therefore, at the time t42, when the parameter signal Sp33 (trigger signal St) from the third ECU 20c is received (S33 in FIG. 5: TRUE), the first ECU 20a stores the received parameter signal Sp33 (S34).

After the timing at which it is expected to receive the parameter signal Sp33 (trigger signal St) from the third ECU 20c, the timer TMR becomes more than or equal to the timer threshold THtmr (S35 in FIG. 5: TRUE). Thus, the first ECU 20a that is currently performing the monitor control performs the determination in steps S37 and S38 in FIG. 5.

In the example of FIG. 7, the order of signals received by the first ECU 20a is Sp21, Sp32, Sp22, and Sp33, which is not normal (S37: FALSE), and the time intervals of the signals Sp21, Sp32, Sp22, and Sp33 are not normal as well (S38: FALSE). Therefore, the first ECU 20a performs an error output indicating the abnormal state of the network 14 (S39 in FIG. 5).

Based on the error output, the first to third ECUs 20a to 20c cancel the communications.

### <A-3. Effect of the Present Embodiment>

As described above, according to the present embodiment, the first ECU 20a (monitor device) determines whether the communications network 14 is in the abnormal state on the basis of the reception status of the trigger signal St and the response signal Sr from the second ECU 20b (first communications device) and the third ECU 20c (second communications device), and outputs the abnormal state if the abnormal state is determined (S39 in FIG. 5). The response signal Sr is generated with respect to the trigger signal St (FIG. 4). Therefore, regardless of whether the trigger signal St is periodic, whether the communications network 14 is in the abnormal state can be determined based on the reception status of the trigger signal St and the response signal Sr.

In the present embodiment, the first ECU 20a (monitor device) determines whether the communications network 14 is in the abnormal state on the basis of the order of receiving the trigger signals St and the response signals Sr (S37 in FIG. 5). Thus, the monitor unit 86 can determine whether the communications network 14 is in the abnormal state by a relatively simple method.

In the present embodiment, when the trigger signal St is received (S21 in FIG. 4: TRUE), the second ECU 20b or the third ECU 20c (first communications device or second communications device) transmits the response signal Sr within a first predetermined time (S23). If the time intervals of the trigger signals St and the response signals Sr are not normal (S38 in FIG. 5: FALSE), in other words, if the response signal Sr is not received within a second predetermined time after the reception of the trigger signal St, the first ECU 20a (monitor device) determines that the network 14 is in the abnormal state (S39). Thus, the first ECU 20a can determine whether the communications network 14 is in the abnormal state by a relatively simple method.

Here, the second predetermined time may be the same as the first predetermined time. In other words, by monitoring the control cycle (calculation cycle, transmission cycle, or the like) in which the response signal Sr should be transmitted, the first ECU 20a (monitor device) can determine whether the communications network 14 is in the abnormal state.

For example, the time from the time point t18 at which the second ECU 20b receives the parameter signal Sp32 (FIG. 6) as the trigger signal St and to the time point t19 at which the second ECU 20b transmits the parameter signal Sp22 as the response signal Sr is set as the first predetermined time. In addition, the time from the time point t18 at which the first ECU 20a receives the parameter signal Sp32 as the trigger signal St and to the time point t20 at which the first ECU 20a receives the parameter signal Sp22 as the response signal Sr is set as the second predetermined time.

In this case, although there is a little time difference between the time point t19 and the time point t20, the control cycle (cycle for the timing of transmitting and receiving the signal) is the same. Therefore, the first predetermined time and the second predetermined time can be regarded as being substantially the same. In addition, when the first predetermined time and the second predetermined time are substantially the same, it is possible to set relatively accurately the timing at which the first ECU 20a receives the response signal Sr.

### B. Modification

Note that the present invention is not limited to the above embodiment, and can employ various structures on the basis of the description of the present specification. For example, structures to be described below can be employed.

### <B-1.Application Object>

In the above embodiment, the communications system 12 is employed for the vehicle 10 (FIG. 1). However, for example, the present invention is not limited to this structure from the viewpoint of determining whether the communications network 14 is in the abnormal state on the basis of the reception status of the trigger signal St and the reception signal Sr. For example, the communications system 12 can be employed for a moving body such as a ship or an aircraft.

The communications network 14 according to the above embodiment is the CAN that is a closed network in the vehicle 10; however, the communications network 14 may be a public network such as the Internet.

### <B-2. Structure of Network 14>

In the above embodiment, the network 14 includes three ECUs 20a to 20c (FIG. 1). However, for example, the present invention is not limited to this structure from the viewpoint of determining whether the communications network 14 is in the abnormal state on the basis of the reception status of the trigger signal St and the reception signal Sr. For example, the network 14 may include four or more ECUs 20 (communications devices and monitor devices).

In the above embodiment, the first to third ECUs 20a, 20b, 20c belong to the same network 14 (FIG. 1). However, for example, the present invention is not limited to this structure from the viewpoint of determining whether the communications network 14 is in the abnormal state on the basis of the reception status of the trigger signal St and the reception signal Sr. For example, the first to third ECUs 20a, 20b, 20c may belong to different networks 14 that are connected with each other through the gateway 22 or the like.

### <B-3. Overall Controls>

In the above embodiment, the first ECU 20a that transmits the trigger signal St performs the monitor control (FIG. 6 and FIG. 7). However, for example, the present invention is not limited to this structure from the viewpoint of determining whether the communications network 14 is in the abnormal state on the basis of the reception status of the trigger signal St and the reception signal Sr. For example, the third ECU 20c may perform the monitor control on the basis of the trigger signal St transmitted from the first ECU 20a (for example, parameter signal Sp11 in FIG. 6) and the response signal Sr transmitted from the second ECU 20b (for example, parameter signal Sp21 in FIG. 6).

### <B-4. Response Signal Transmission Control>

In the response signal transmission control (FIG. 4) according to the above embodiment, the response signal Sr is transmitted every time the trigger signal St is received. However, for example, the present invention is not limited to this structure from the viewpoint of determining whether the communications network 14 is in the abnormal state on the basis of the reception status of the trigger signal St and the reception signal Sr. For example, the response signal Sr can be transmitted when the trigger signal St is received predetermined times (for example, three times).

### <B-5. Monitor Control>

In the monitor control (FIG. 5) according to the above embodiment, it is determined whether the order is normal (S37) and whether the time intervals are normal (S38). However, for example, the present invention is not limited to this structure from the viewpoint of determining whether the communications network 14 is in the abnormal state on the basis of the reception status of the trigger signal St and the reception signal Sr. For example, one of both determinations can be omitted.

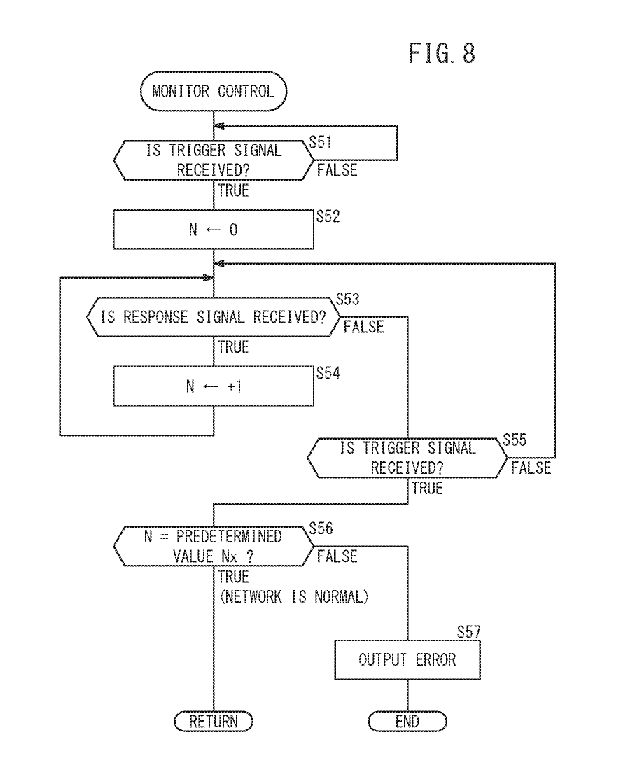

FIG. 8 is a flowchart of the monitor control according to the modification. In the modification in FIG. 8, whether the communications network 14 is in the abnormal state is determined based on the number of times N of receiving the response signal Sr after the trigger signal St is received and before the trigger signal St is received next time.

In step S51 in FIG. 8, the monitor unit 86 of the monitor ECU 20mon (for example, first ECU 20a) determines whether the trigger signal St is received. If the trigger signal St is received (S51: TRUE), the process advances to step S52. If the trigger signal St is not received (S51: FALSE), step S51 is repeated. In step S52, the monitor ECU 20mon resets the number of times N of receiving the response signal Sr.

In step S53, the monitor ECU 20mon determines whether the response signal Sr is received. If the response signal Sr is received (S53: TRUE), the monitor ECU 20mon increases the number of receiving times N by one in step S54; then, the process returns to step S53. If the response signal Sr is not received (S53: FALSE), the process advances to step S55.

In step S55, the monitor ECU 20mon determines whether a new trigger signal St is received. If the new trigger signal St is not received (S55: FALSE), the process returns to step S53. If the new trigger signal St is received (S55: TRUE), the process advances to step S56.

In step S56, the monitor ECU 20mon determines whether the number of receiving times N is a predetermined value Nx (for example, one). If the number of receiving times N is the predetermined value Nx (S56: TRUE), the monitor ECU 20mon determines that the network 14 is normal. In this case, the monitor ECU 20mon may store a normal flag in the storage unit 54, for example. Alternatively, the monitor ECU 20mon can store no data.

If the number of receiving times N is not the predetermined value Nx (S56: FALSE), it is assumed that an unauthenticated ECU 20 is connected to the network 14 and the unauthenticated ECU 20 transmits an unauthenticated response signal Sr, for example. In this case, the monitor ECU 20mon outputs an error indicating the abnormal state of the communications network 14 in step S57. Specifically, the monitor ECU 20mon turns on a warning lamp that is not shown. Alternatively, the monitor ECU 20mon may store a DTC in the storage unit 54.

In the modification in FIG. 8, the monitor ECU 20mon (monitor device) determines whether the communications network 14 is in the abnormal state on the basis of the number of times N of receiving the response signal Sr after the trigger signal St is received and before the trigger signal St is received next time. Thus, whether the communications network 14 is in the abnormal state can be determined by using the reception intervals of the trigger signals St.

In the modification in FIG. 8, whether the network 14 is in the abnormal state is determined based on the number of times N of receiving the response signal Sr after the trigger signal St is received and before the trigger signal St is received next time; however, the trigger signal St may be replaced with the response signal Sr. That is to say, whether the communications network 14 is in the abnormal state may be determined based on the number of times N of receiving the trigger signal St after the response signal Sr is received and before the response signal Sr is received next time.

### <B-6. Others>

In the above embodiment, when the numerals are compared, the formula includes or does not include an equal sign (for example, S35 in FIG. 5). However, for example, whether an equal sign is used to compare the numerals can be set arbitrarily unless using or not using the equal sign has a special meaning (i.e., if the effect of the present invention is obtained).

In this sense, for example, the determination as to whether the timer TMR in step S35 in FIG. 5 is more than or equal to the timer threshold THtmr (TMR≥THtmr) can be replaced with the determination as to whether the timer TMR is more than the timer threshold THtmr (TMR>THtmr).

### C. Explanation Of Reference Symbols

12: communications system
14: communications network
20a: first ECU (first communications device, monitor device)
20b: second ECU (first communications device, second communications device)
20c: third ECU (second communications device)
Sr: response signal
St: trigger signal

What is claimed is:

1. A communications system comprising:
a first communications device configured to generate a trigger signal and transmit the trigger signal to a communications network;
a second communications device configured to receive the trigger signal through the communications network, generate a response signal with respect to the trigger signal, and transmit the response signal to the communications network; and
a monitor device configured to receive the trigger signal and the response signal through the communications network, and determine whether the communications network is in an abnormal state on a basis of a reception status of the trigger signal and the response signal.

2. The communications system according to claim 1, wherein the monitor device is configured to determine whether the communications network is in the abnormal state on a basis of an order of receiving the trigger signal and the response signal.

3. The communications system according to claim 1, wherein the monitor device is configured to determine whether the communications network is in the abnormal state on a basis of number of times of receiving the response signal after the trigger signal is received and before the trigger signal is received next time, or number of times of receiving the trigger signal after the response signal is received and before the response signal is received next time.

4. The communications system according to claim 1, wherein:
if the trigger signal is received, the second communications device is configured to transmit the response signal within a first predetermined time; and
if the response signal is not received within a second predetermined time after the trigger signal is received, the monitor device is configured to determine that the communications network is in the abnormal state.

5. The communications system according to claim 4, wherein the second predetermined time is same as the first predetermined time.
